(19) United States
(12) Patent Application Publication
(10) Pub. No.: US 2008/0060233 A1
(43) Pub. Date: Mar. 13, 2008

(54) Calendar

(76) Inventor: Deok Hwan Choi, Seoul (KR)

Correspondence Address: SALIWANCHIK LLOYD & SALIWANCHIK;A PROFESSIONAL ASSOCIATION, PO BOX 142950, GAINESVILLE, FL, 32614-2950, US

(21) Appl. No.: 11/850,825

(22) Filed: Sep. 6, 2007

(30) Foreign Application Priority Data
Sep. 12, 2006 (KR) 10-2006-0088075

(51) Int. Cl. G09D 3/00

(52) U.S. Cl. 40/107

(57) ABSTRACT

Disclosed herein is a calendar. The calendar includes plurality of sheets of calendar paper, and a plurality of sheets of foldable paper. The sheets of calendar paper are bound by a binding means so as to be able to rotate. Each of the sheets of foldable paper have a foldable structure in which at least one folding portion is formed on the upper edge of each of the sheets of calendar paper. The sheets of foldable paper extend from the respective edges of the sheets of calendar paper. Thus, the efficiency of use of space can be increased without increasing the size of the calendar.

### PRIORITY STATEMENT

This non-provisional application claims priority under U.S.C. § 119 to Korean Patent Application No. 10-2006-88075, filed on Sep. 12, 2006 in the Korean Intellectual Property Office (KIPO), the entire contents of which are herein incorporated by reference.

### BACKGROUND

1. Field

Example embodiments relate generally to a calendar and, more particularly, to a calendar having an improved structure, in which at least one sheet of foldable paper, having a foldable structure, is formed on the upper, lower, left or right edge of each sheet of calendar paper on which dates are printed, thus increasing the efficiency of use of space and improving the performance of display and, in addition, protecting personal privacy.

2. Description of the Related Art

Generally, a desktop calendar includes a triangular support that is made of a triangle of thick cardboard so that it can be stood up on a desk, and has a structure in which the ends of sheets of calendar paper, resting on one surface or another surface of the triangular support, are bound by a binding ring, which is formed of a coil spring, so as to be able to rotate.

However, in a conventional desktop calendar, sheets of calendar paper are bound by a spring type of binding ring so that they can rotate, as described above, and thus the calendar paper used during the past month is generally torn and thrown away, or alternatively the front surface of the used calendar paper must be hidden by turning over the used calendar paper.

Furthermore, the conventional desktop calendar is problematic in that the sheets of calendar paper are configured to have a simple structure, so that a user can only view an unchanging and boring image. As a result, the customers are not stimulated to purchase the calendar.

Furthermore, the conventional desktop calendar is problematic in that there is a spatial limitation to where advertisements can be printed because there are insufficient blank spaces in which dates are not printed, and in that the advertising effect is decreased because visual attention is not paid to advertisements even though the advertisements are printed around the periphery of the calendar.

Furthermore, the conventional desktop calendar is disadvantageous in that pieces of information other than dates are printed and arranged so as to increase the efficiency of spatial arrangement, and in that, when the space is occasionally insufficient, the size of the printed characters must be reduced, or the entire size of the calendar must be increased.

Furthermore, the conventional desktop calendar is problematic in that, when a user writes personal information on a calendar paper, the calendar paper is provided as a sheet of calendar paper, on which a calendar month is printed, and the surface on which the information is written is always located such that it faces forwards, so that personal information written on the calendar paper is externally exposed to other people, with the result that personal privacy cannot be protected.

### SUMMARY

Accordingly, example embodiments have been made keeping in mind the above problems occurring in the prior art, and provides a calendar having an improved structure, which can provide a large amount of information without having an increased overall size, and can also provide various functions, such as the functions of a picture frame and a memo.

Furthermore, example embodiments provide a calendar, which is manufactured to have a twin structure, in which outer surfaces and inner surfaces are provided, so that the front surface of each sheet of calendar paper, on which personal information is written, is prevented from being exposed but separate covers are not required to be manufactured, with the result that the invasion of personal privacy can be prevented.

According to example embodiments, a calendar may include a plurality of sheets of calendar paper bound by a binding means so as to be able to rotate; and sheets of foldable paper, each having a foldable structure in which at least one folding portion is formed on the upper edge of each of the sheets of calendar paper, and extending from the respective edges of the sheets of calendar paper.

The binding means is a binding ring inserted into one or more binding holes, which are formed in each of the sheets of calendar paper, and into one or more binding holes, which are formed in each of the sheets of foldable paper, and configured to bind the sheets of calendar paper and the sheets of foldable paper so that the sheets of calendar paper and the sheets of foldable paper can be rotated.

The calendar may further include coupling means for coupling the sheets of foldable paper with the sheets of calendar paper so that they are selectively in close contact with each other. The coupling means is configured such that one or more fitting protrusions are formed on an edge of each of the sheets of foldable paper, and fitting holes are formed in each of the sheets of calendar paper to correspond to the fitting protrusions of each of the sheets of foldable paper.

In addition, a calendar may include a plurality of sheets of calendar paper bound by binding means so as to be able to rotate; and sheets of foldable paper, each having a foldable structure in which at least one folding portion is formed on at least one edge selected from among lower, left and right edges of each of the sheets of calendar paper, and extending from the respective selected edges of the sheets of calendar paper.

A plurality of cut fitting holes may be formed in each of the sheets of foldable paper so that edges of a picture are fitted into each of the sheets of foldable paper. Furthermore, at least one viewing window is formed to pass through the sheets of calendar paper.

In addition, a calendar may include a plurality of sheets of calendar paper bound by binding means so as to be able to rotate; and sheets of foldable paper, each having a foldable structure in which respective folding portions are formed on at least two edges selected from among upper, lower, left and right edges of each of the sheets of calendar paper, and extending from the respective selected edges of the sheets of calendar paper.

### BRIEF DESCRIPTION OF THE DRAWINGS

Example embodiments will be more clearly understood from the following detailed description taken in conjunction with the accompanying drawings, in which:

FIG. 1 is a perspective view showing a calendar according to a first embodiment of example embodiments:

FIG. 2 is a perspective view showing the connection structure of a calendar according to the first embodiment of example embodiments with a sheet of foldable paper.

FIG. 3 is a rear perspective view of FIG. 2;

FIG. 4 is a perspective view showing a modification of the calendar according to the first embodiment of example embodiments;

FIG. 5 is a perspective view showing the arrangement of sheets of calendar paper and sheets of foldable paper, shown in FIG. 4;

FIG. 6 is a view showing the use of the calendar of FIG. 4;

FIG. 7 is a perspective view showing another embodiment of the calendar according to the first embodiment of example embodiments;

FIG. 8 is a perspective view showing a calendar according to a second embodiment of example embodiments;

FIG. 9 is a perspective view showing a sheet of calendar paper and a sheet of foldable paper, which are principal parts of the calendar according to the second embodiment of example embodiments;

FIG. 10 is a view showing the use of the calendar of the second embodiment of example embodiments;

FIG. 11 is a perspective view showing a modification of the calendar according to the second embodiment of example embodiments;

FIG. 12 is a perspective view showing another modification of the calendar according to the second embodiment of example embodiments;

FIG. 13 is a perspective view showing a calendar according to a third embodiment of example embodiments;

FIG. 14 is a perspective view showing a sheet of calendar paper and a sheet of foldable paper, which are principal parts of the calendar according to the third embodiment of example embodiments;

FIG. 15 is a view showing the use of the calendar according to the third embodiment of example embodiments;

FIG. 16 is a perspective view showing a calendar according to a fourth embodiment of example embodiments;

FIG. 17 is a perspective view showing a modification of the calendar according to the fourth embodiment of example embodiments;

FIG. 18 is a perspective view showing a calendar according to a fifth embodiment of example embodiments;

FIG. 19 is a perspective view showing a sheet of calendar paper and two sheets of foldable paper, which are principal parts of the calendar according to the fifth embodiment of example embodiments;

FIG. 20 is a view showing the use of the calendar according to the fifth embodiment of example embodiments; and

FIG. 21 is a perspective view a calendar according to a sixth embodiment of example embodiments.

### DETAILED DESCRIPTION OF EXAMPLE EMBODIMENTS

Preferred embodiments of example embodiments are described in detail with reference to the accompanying drawings. In the description of the following embodiments, the same reference numerals are used to designate the same or similar components, and the repeated description will be omitted.

### First Embodiment

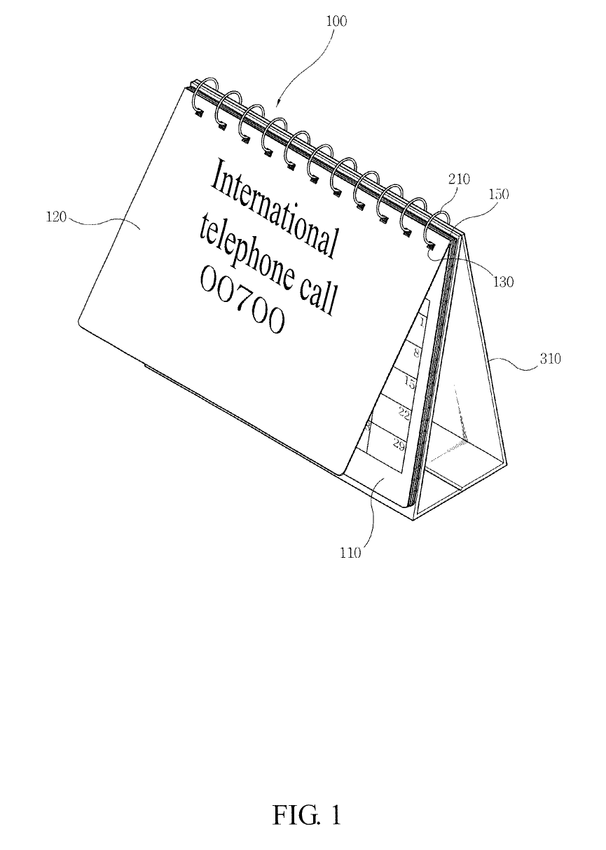

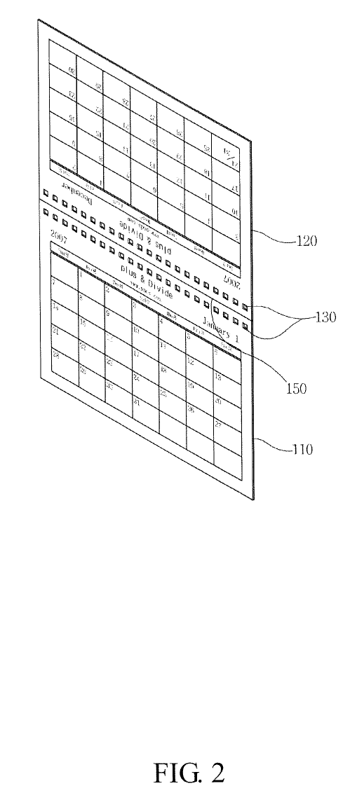

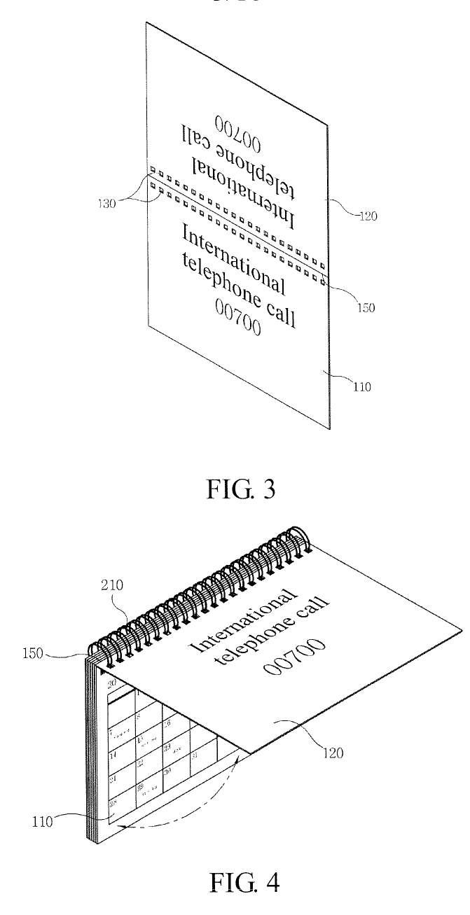

A calendar according to a first embodiment of example embodiments is described with reference to FIGS. 1 to 3. The calendar of the present embodiment has a structure in which a plurality of sheets of calendar paper 110 is bound by a binding ring 210 so as to be able to rotate, and sheets of foldable paper 120, each having a foldable structure, extend from folding portions 150 formed on the respective upper edges of the sheets of calendar paper 110.

In the case of a desktop calendar, the sheets of calendar paper 110 are configured to be supported by a triangular support 310 and to be stood up on a desk.

The folding portions 150 correspond to the respective boundary portions of the sheets of calendar paper 110 and the sheets of foldable paper 120. The folding portions 150 allow the sheets of foldable paper 120 to be able to rotate around the respective folding portions 150 of the sheets of calendar.

The sheets of foldable paper 120 are configured to extend from the respective edges of the sheets of calendar papers 110 and to cover the respective front surfaces of the sheets of calendar paper 110. Accordingly, the sheets of foldable paper 120 and the sheets of calendar paper 110 are configured to have outer surfaces and inner surfaces that can overlap using the folding portions 150.

In greater detail, the outer surfaces of the sheets of foldable paper 120 are used as portions for printing or showing desired advertising slogans, and thus a function of blank spaces, to which a special image can be assigned, can be achieved. Furthermore, portions on which actual dates are printed are located on both the inner surfaces of the sheets of calendar paper 110 and the inner surfaces of the sheets of foldable paper 120, and thus a cover function for preventing personal information or the like, which is written on the sheets of calendar paper 110, from being exposed to the outside can be achieved.

Reference numeral “130” designates a plurality of binding holes which are formed in the sheets of foldable paper 120 and in the sheets of calendar paper 110 to bind the sheets of foldable paper 120 and the sheets of calendar paper 110 to each other using the binding ring 210.

The operation of the first embodiment of example embodiments, constructed as described above, is described below. In the calendar 100 according to the first embodiment of example embodiments, the sheets of calendar paper 110 are bound by the binding ring 210 so as to be able to rotate. The sheets of foldable paper 120, extending from the respective upper edges of the sheets of calendar paper 110, are configured to cover the respective front surfaces of the sheets of calendar paper 110. Dates are printed on the front surface of each sheet of calendar paper 110. Accordingly, the primary function as a calendar can be achieved, and separate advertising slogans or messages can also be printed on the outer surface of each sheet of foldable paper 120.

In this case, a user can hold up a sheet of foldable paper 120 and then view a sheet of calendar paper 110 on which dates are printed, or can check pieces of personal information or due dates on the corresponding sheet of calendar paper 110 using a writing instrument. When the sheet of foldable paper 120 is allowed to fall down again, the outer surface of the foldable paper 120, on which advertising slogans are printed, is always oriented forwards. Accordingly, there are advantages in that an advertisement effect can be achieved, and in that the sheet of calendar paper 110, on which the pieces of personal information is written, cannot be easily viewed by other people.

Furthermore, in the case where the sheets of foldable paper 120 and the sheets of calendar paper 110 have the same size, dates are symmetrically printed based on the folding portions 150, and the binding holes 130 of each sheet of foldable paper 120 are formed to be symmetric with the binding holes 130 of each sheet of the calendar paper 110. Accordingly, two calendar months can be provided using a sheet of foldable paper 120 and calendar paper 110 which are integrated with each other, and the outer surfaces of both the sheets of foldable paper 120 and the sheets of calendar paper 110 can be used as blank spaces, on which advertisement phases are printed.

In the first embodiment of example embodiments, it is preferred that dates be symmetrically printed on the inner surface of each sheet of calendar paper 110 and the inner surface of each sheet of foldable paper 120 located opposite each other. For example, calendar months ranging from January to June are printed on the respective front surfaces of the sheets of calendar paper 110, and calendar months ranging from July to December are printed on the respective rear surfaces of the foldable paper 120, which are opposite the front surfaces of the sheets of the calendar paper 110, so as to be symmetric with the former months.

Accordingly, the calendar can be used in such a way that the sheets of calendar paper 110, on which the calendar months ranging from January to June are printed, are used in the state in which the inner surfaces of the sheets of calendar paper 110 are oriented frontward, and, subsequently, the inner surfaces of the sheets foldable paper 120, on which the calendar months ranging from July to December are printed, are oriented forwards by turning the calendar.

That is, the calendar months ranging from January to June are printed on the respective inner surfaces of the sheets of calendar paper 110, and the calendar months ranging from July to December are printed on the respective inner surfaces of the sheets of foldable paper 120, so that the inner surfaces of the sheets of calendar paper 110, on which the calendar months are printed, can be covered by the respective outer surfaces of the sheets of the foldable paper 120, so that other people cannot easily view the inner surfaces. In contrast, the outer surfaces of the sheets of calendar paper 110 can be used as covers for the inner surfaces of the sheets of foldable paper 120, on which the calendar months ranging from July to December are printed.

Furthermore, in the present embodiment, the sheets of calendar paper 110 and the sheets of foldable paper 120 can be manufactured in such a way that a single sheet of calendar paper and a single sheet of foldable paper overlap each other based on a folding portion 150, and thus the productivity thereof can be improved.

In this case, the calendar 100 of example embodiments may be implemented such that dates are printed only on the front surfaces of the sheets of calendar paper 110 for convenience of the user.

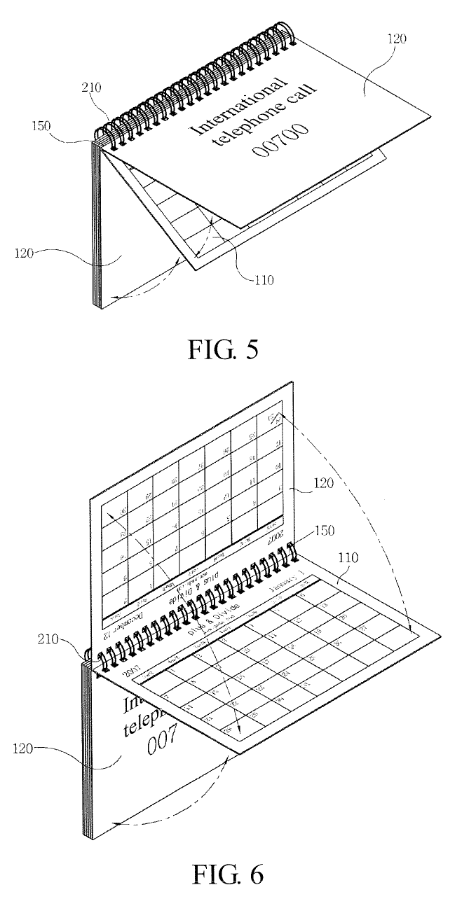

FIGS. 4 to 6 are views showing a modification of the first embodiment of example embodiments. The modification relates to a calendar in which the triangular support 310 is omitted, unlike the first embodiment, described above, and has a structure in which a plurality of sheets of calendar paper 110 and a plurality of sheets of foldable paper 120, which can be rotated around folding portions 150, are bound by a binding ring 210.

This means that the calendar of example embodiments may be implemented not only as a calendar from which the triangular support is omitted, but also in various other ways.

Accordingly, the sheets of calendar paper 110 and the sheets of foldable paper 120 have inner surfaces and outer surfaces. The procedure for symmetrically printing the dates of calendar months on the inner surfaces and forming advertising slogans on the outer surfaces is the same as in the first embodiment. In the case where the calendar is used on a monthly basis, the user can view a desired calendar month by turning a set of a sheet of foldable paper 120 and a sheet of calendar paper 110 upward.

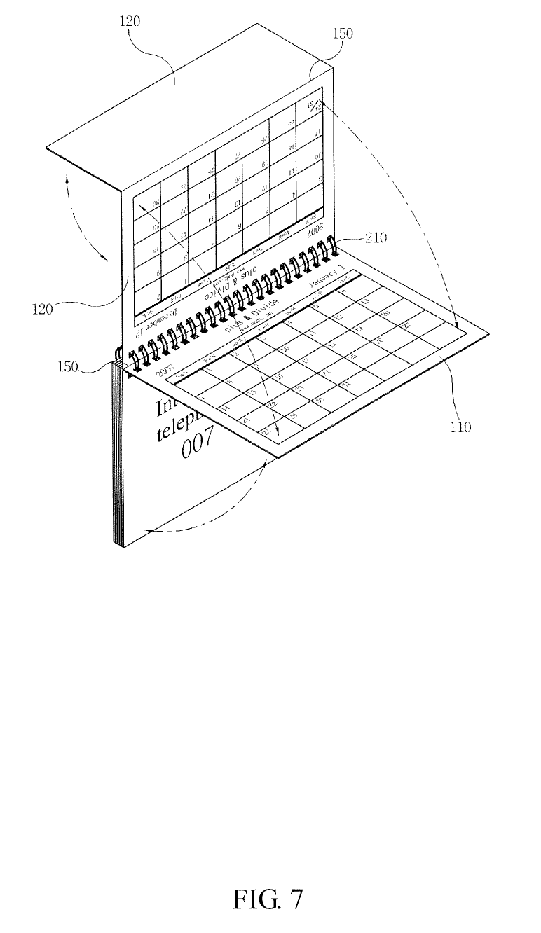

FIG. 7 is a view showing another modification of the first embodiment of example embodiments. A plurality of sheets of foldable paper 120 is manufactured to have a size larger than that of sheets of calendar paper 110, and is folded using a plurality of folding portions 150.

This means that each sheet of foldable paper 120 may be configured to be folded several times using a plurality of folding portions 150.

### Second Embodiment

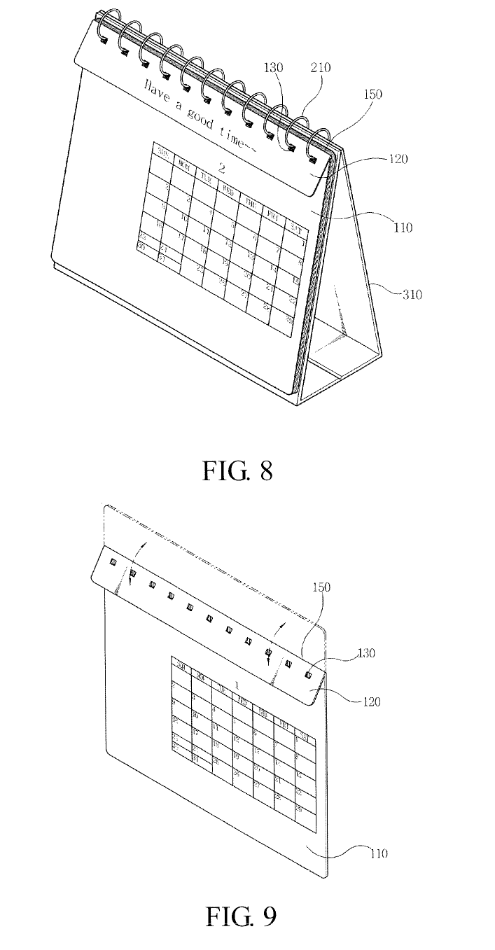

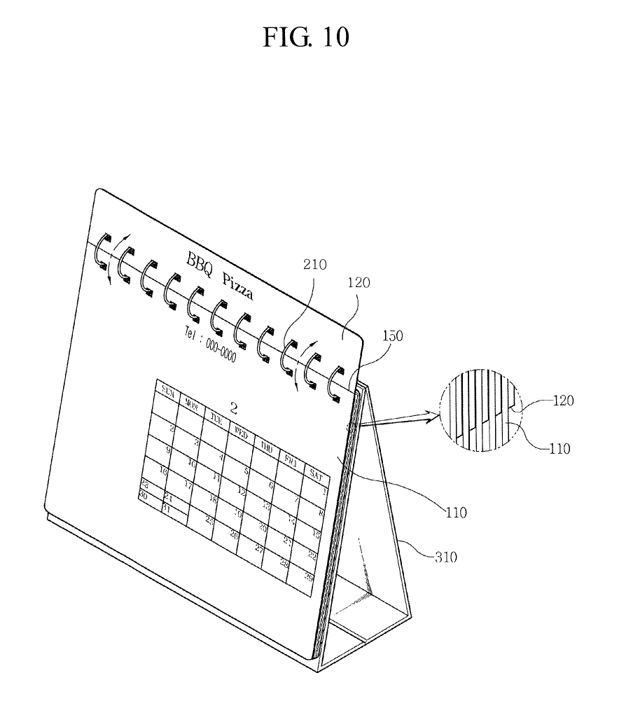

FIGS. 8 to 10 are views showing a calendar according to a second embodiment of example embodiments. The calendar of the present embodiment is the same as that of the first embodiment in that sheets of foldable paper 120, each having a foldable structure, extend from respective sheets of calendar paper 110 to be able to rotate around folding portions 150 formed on the upper edges of the sheets of calendar paper 110, but differs from the first embodiment in that the sheets of foldable paper 120 are formed to have a size smaller than that of the sheets of calendar paper 110.

Accordingly, the outer and inner surfaces of the sheets of foldable paper 120 can be used as blank spaces on which advertising slogans are written, and the upper portions of the sheets of calendar paper 110, which are covered by the sheets of foldable paper 120, can also be used as different spaces in which messages or advertising slogans can be printed.

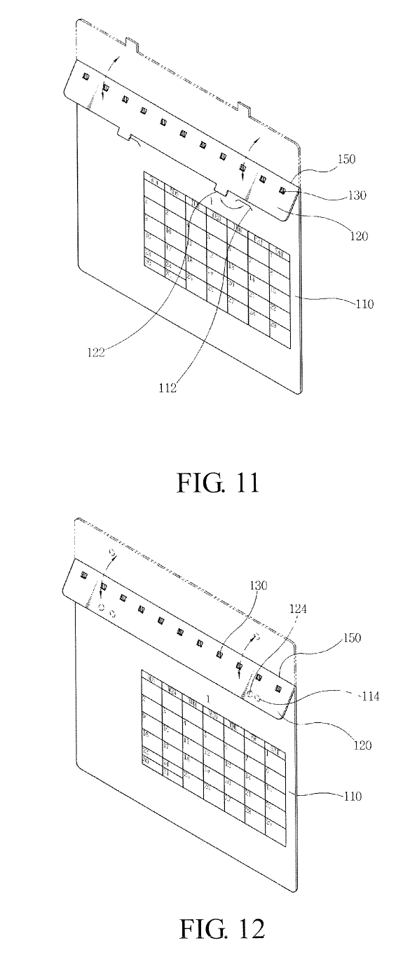

The second embodiment may further include coupling means, so that the sheets of foldable paper 120 are in close contact with the sheets of calendar paper 110. As shown in FIG. 11, the coupling means is configured such that one or more fitting protrusions 122 extends from the edge of each sheet of foldable paper 120, fitting holes 112, corresponding to the fitting protrusions 122, are formed in each sheet of calendar paper 110, and the sheet of foldable paper 120 is brought into close contact with the sheet of calendar paper 110 by fitting the sheet of foldable paper 120 into the sheet of calendar paper 110.

Meanwhile, as shown in FIG. 12, another example of the coupling means is configured such that magnetic elements 114 and magnetic elements 124 are formed in contact portions of each sheet of foldable paper 120 and each sheet of calendar paper 110 and, thus, detachable attachment can be achieved using the attractive force of the magnet elements 114 and 124.

In this case, when the coupling means is provided, the sheets of foldable paper 120 can be brought into contact with the front surfaces of the sheets of calendar paper 110 using the coupling means. Accordingly, the elegant appearance of the calendar can be maintained because the sheets of foldable paper 120 are in contact with the respective front surfaces of the sheets of calendar paper 110.

Furthermore, a design can be made such that the edges of each sheet of the foldable paper 120 have a round shape or such that predetermined patterns are assigned thereto, and thus a function of providing a decorative appearance can be improved. Furthermore, as another purpose of use, the sheets of foldable paper 120 may function as a writable memo pad by forming blank spaces on the rear surfaces of the sheets of foldable paper 120.

### Third Embodiment

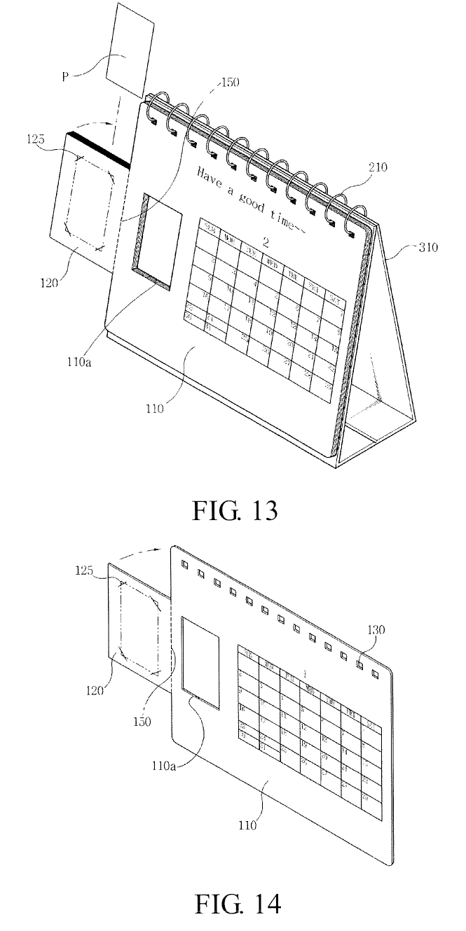

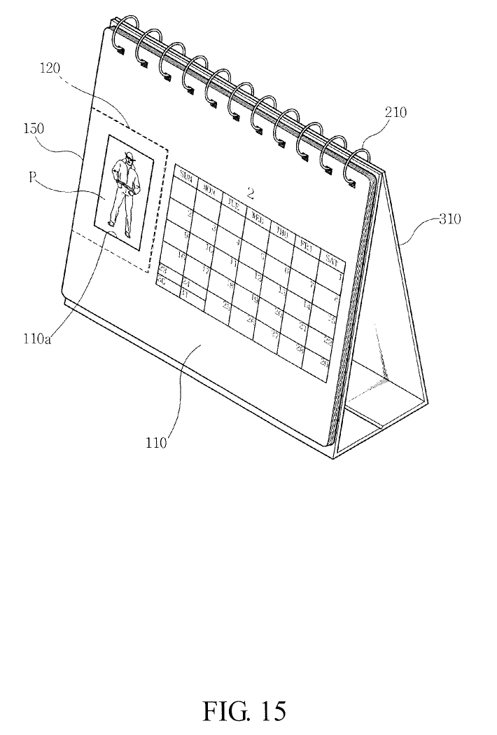

FIGS. 13 to 15 are views showing a calendar according to a third embodiment of example embodiments. Unlike the first and second embodiments, described above, the calendar of the present embodiment is not configured such that sheets of foldable paper 120 are formed in portions in which bonding is made by a bonding ring 210, but is configured such that sheets of foldable paper 120, each having a foldable structure, extend from respective side edges of sheets of calendar paper 110 to be able to rotate around folding portions 150.

Each of the sheets of foldable paper 120 may further include a function of a picture frame which can contain a picture p, in addition to a function of providing only a space. For this purpose, a viewing window 110a is formed to pass through a corresponding portion of the sheets of calendar paper 110, which are in close contact with the respective sheets of foldable paper 120, and a plurality of cut coupling holes 125 is formed on the surface of each foldable paper 120 so that the edges of a picture P can be fitted.

In addition, although not shown in the drawings, the sheets of foldable paper 120 may be implemented such that pictures are attached to the respective sheets of foldable paper 120 using an adhesive agent, rather than using the coupling holes 125.

In this case, a picture P is supported so that it is kept in close contact with the rear surface of a single sheet of foldable paper 120 using the coupling holes 125. When a sheet of foldable paper 120 is rotated around a folding portion 150 toward the rear surface of a sheet of calendar paper 110, a picture P is located to correspond to the viewing window 110a of the sheet of calendar paper 110, and thus the sheet of calendar paper 110 and the sheet of foldable paper 120 function as a picture frame.

### Fourth Embodiment

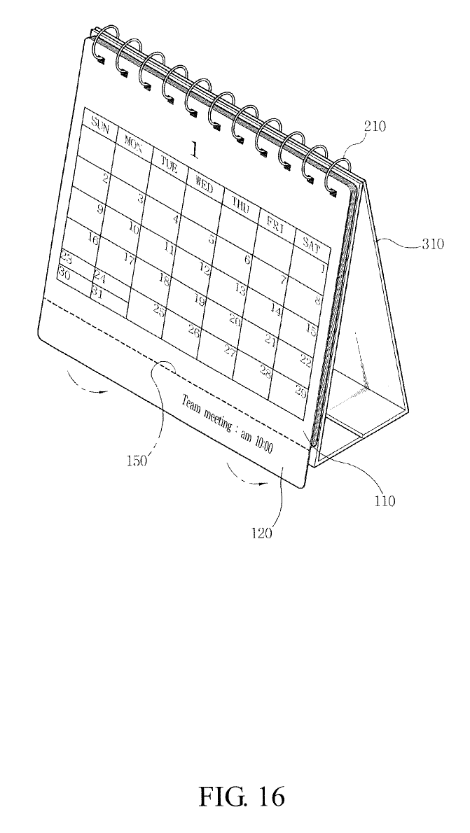

FIG. 16 is a view showing a calendar according to a fourth embodiment of example embodiments. Unlike the first, second and third embodiments, described above, the calendar of the present embodiment is configured such that sheets of foldable paper 120, each having a rotatable foldable structure, extend from the respective upper edges of sheets of calendar paper 110 to be able to rotate around folding portions 150, and thus can be turned over.

Accordingly, the length of each sheet of calendar paper 110 can be increased because the sheets of foldable paper 120 extend from the respective lower edges of the sheets of calendar paper 110 as described above.

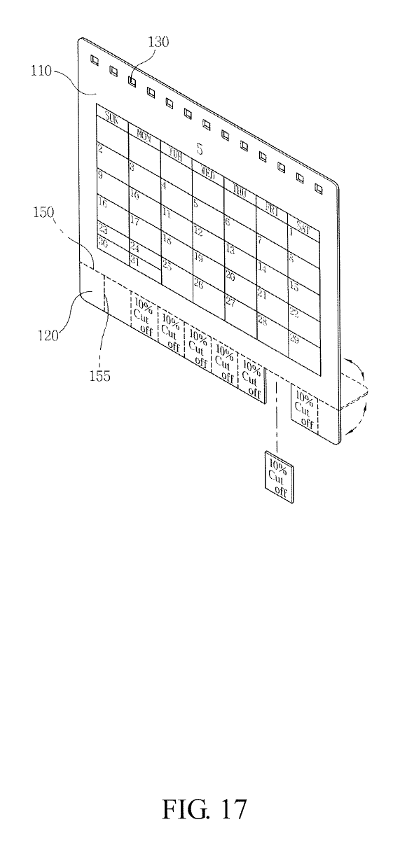

FIG. 17 is a view showing a modification of the fourth embodiment of example embodiments. In the modification, cutting portions 155 are provided such that each of the sheets of foldable paper 120 that extend from the respective lower edges of sheets of calendar paper 110 to be able to rotate around folding portions 150 is divided into a plurality of bits. In this case, the bits of paper may be used, for example, as coupons.

### Fifth Embodiment

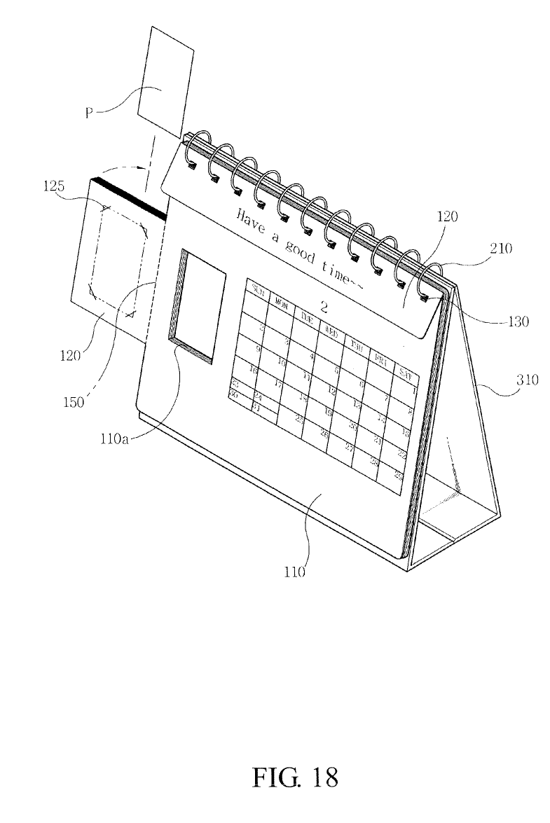

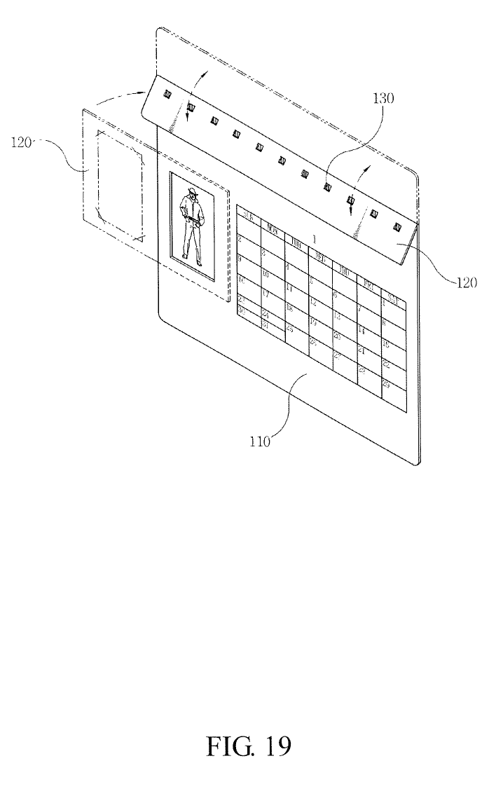

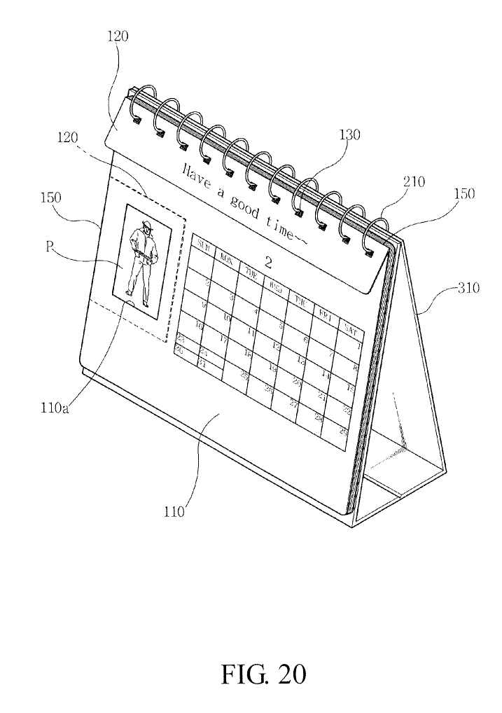

FIGS. 18 to 20 are views showing a calendar according to a fifth embodiment of example embodiments. Unlike the first, second, third and fourth embodiments, described above, the calendar of the present embodiment is configured such that two or more sheets of foldable paper 120 are provided on the respective edges of each sheet of calendar paper 110 so that they are able to rotate around respective folding portions 150. This means that the two or more sheets of foldable paper 120 may extend from the respective edges of each sheet of calendar paper 110.

### Sixth Embodiment

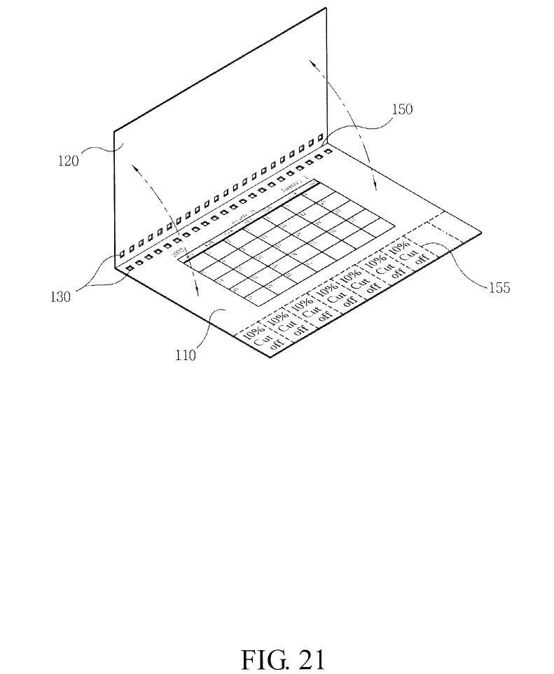

FIG. 21 is a view showing a calendar according to a sixth embodiment of example embodiments. The calendar of the present embodiment is configured to have a structure having a concept that is the opposite of that of the modification of the fourth embodiment, described above. In greater detail, the calendar is configured such that sheets of foldable paper 120 are longer than sheets of calendar paper 110, and one or more cutting portions 155 are formed in the end of each sheet of calendar paper 110, having a length longer than that of the sheets of foldable paper 120, and thus the end thereof can be divided into a plurality of bits of paper. In this case, the bits of paper may be used, for example, as coupons.

The above-described embodiments of example embodiments have a technical spirit and concept in which at least one sheet of foldable paper 120, each having a foldable structure, extends from at least one edge selected from among the upper edge of each sheet of calendar paper 110, which is bound by a binding ring 210, and the lower, left and right edges of the sheet of calendar paper 110 so as to be able to rotate around a corresponding folding portion 150, and may be modified and implemented in various ways within the range that does not depart from the technical spirit and concept of example embodiments. For example, the sheets of foldable paper 120, each having a foldable structure and extending from the respective edge of the sheets of calendar paper, may be implemented in various forms regardless of the length or shape thereof.

Example embodiments, described above, relates to a calendar having an improved structure, in which sheets of calendar paper are configured to have a foldable structure, thus increasing the efficiency of use of space without increasing the size thereof. According to example embodiments, at least one sheet of foldable paper extends from at least one edge selected from the edges of each sheet of calendar paper so as to be able to rotate around a corresponding folding portion, so that the efficiency of use of space can be increased due to the sheet of foldable paper, and supplementary functions, such as the functions of memo paper and a picture frame, can be realized.

Furthermore, when sheets of foldable paper are formed to have the same size as sheets of calendar paper, the sheets of calendar paper and the sheets of foldable paper constitute a calendar having inner surfaces and outer surfaces, calendar months are printed on the inner surfaces, and the outer surfaces function as a cover on which advertising slogans are printed, so that the calendar of example embodiments can achieve a more improved advertisement exposure effect and productivity than a sheet of existing calendar paper. Furthermore, the outer surfaces, functioning as covers, cover the sheets of calendar paper or foldable paper on which personal information is written, so that the invasion of personal privacy can be prevented.

Although the preferred embodiments of example embodiments have been disclosed for illustrative purposes, those skilled in the art will appreciate that various modifications, additions and substitutions are possible, without departing from the scope and spirit of the invention as disclosed in the accompanying claims.

What is claimed is:

1. A calendar, comprising:
a plurality of sheets of calendar paper bound by binding means so as to be able to rotate; and
sheets of foldable paper, each having a foldable structure in which at least one folding portion is formed on an upper edge of each of the sheets of calendar paper, and extending from respective edges of the sheets of calendar paper.

2. The calendar as set forth in claim 1, wherein the binding means is a binding ring inserted into one or more binding holes, which are formed in each of the sheets of calendar paper, and into one or more binding holes, which are formed in each of the sheets of foldable paper, and configured to bind the sheets of calendar paper and the sheets of foldable paper so that the sheets of calendar paper and the sheets of foldable paper can be rotated.

3. The calendar as set forth in claim 1, further comprising coupling means for coupling the sheets of foldable paper with the sheets of calendar paper so that they are selectively in close contact with each other.

4. The calendar as set forth in claim 3, wherein the coupling means is configured such that one or more fitting protrusions are formed on an edge of each of the sheets of foldable paper, and fitting holes are formed in each of the sheets of calendar paper to correspond to the fitting protrusions of each of the sheets of foldable paper.

5. The calendar as set forth in claim 1, wherein each of the sheets of foldable paper is formed to have a size identical to that of each of the sheets of calendar paper.

6. The calendar as set forth in claim 1, wherein each of the sheets of foldable paper is formed to have a size smaller than that of each of the sheets of calendar paper.

7. A calendar, comprising:
a plurality of sheets of calendar paper bound by binding means so as to be able to rotate; and
sheets of foldable paper, each having a foldable structure in which at least one folding portion is formed on at least one edge selected from among lower, left and right edges of each of the sheets of calendar paper, and extending from the respective selected edges of the sheets of calendar paper.

8. The calendar as set forth in claim 7, wherein a plurality of cut fitting holes is formed in each of the sheets of foldable paper so that edges of a picture are fitted into each of the sheets of foldable paper.

9. The calendar as set forth in claim 7, wherein at least one viewing window is formed to pass through the sheets of calendar paper.

10. A calendar, comprising:
a plurality of sheets of calendar paper bound by binding means so as to be able to rotate; and
sheets of foldable paper, each having a foldable structure in which respective folding portions are formed on at least two edges selected from among upper, lower, left and right edges of each of the sheets of calendar paper, and extending from the respective selected edges of the sheets of calendar paper.
